(19) United States
(12) Patent Application Publication
(10) Pub. No.: US 2026/0111253 A1
(43) Pub. Date: Apr. 23, 2026

(54) LEVERAGING TRANSFORMER-BASED CENTRALIZED NETWORK DIGITAL TWINS FOR MICROSERVICES ARCHITECTURES

(71) Applicant: Rakuten Mobile, Inc., Tokyo (JP)

(72) Inventors: Razvan-Mihai URSU, Munich (DE); Navidreza ASADI, Munich (DE); Johannes Peter Donato ZERWAS, Munich (DE); Jee Chang, Leon WONG, Setagaya, Tokyo (JP); Wolfgang Leonhard KELLERER, Munich (DE)

(21) Appl. No.: 18/923,675

(22) Filed: Oct. 23, 2024

(51) Int. Cl. G06F 9/455

(52) U.S. Cl. CPC G06F 9/45558; G06F 2009/45595

(57) ABSTRACT

Transformer-based centralized network digital twins for microservices architectures. Data for lagged contexts of a predetermined context length of a microservices architecture is received as input. Based on the received data, output is predicted in an autoregressive manner for a selected prediction length using Machine Learning (ML). The microservices architecture is configured using the output.

### FIELD

The present disclosure relates to leveraging transformer-based centralized network digital twins for microservices architectures.

### BACKGROUND

The information disclosed in this background section is only for enhancement of understanding of the general background of the disclosure and should not be taken as an acknowledgement or any form of suggestion that this information forms the prior art already known to a person skilled in the art.

Applications have traditionally been built as monolithic pieces of software. Monolithic applications have long life cycles, are updated infrequently and changes usually affect the entire application. Adding new features involves reconfiguring and updating the entire stack. This is a costly and cumbersome process that delays time-to-market and updates in application development.

Microservices architecture has gained popularity in recent years, allowing for increased flexibility, scalability, and easier maintenance of complex applications. Microservices architectures are used to build a distributed application by breaking an application into independent, loosely-coupled, individually deployable services. To realize the benefits of a microservices architecture, containers and container orchestration are useful in the deployment process and make such deployment efficient and reliable. Further, as containerization has become more widespread, so has the desire to manage these containers. Kubernetes (K8) and OpenShift are two popular tools that are often used to manage containerized applications. For example, Kubernetes is an open source container orchestration platform that automates the deployment, scaling, and management of containerized applications. OpenShift is another container platform that is designed to streamline the development, deployment, and management of containerized applications.

Container orchestration works by coordinating container deployment across multiple host machines or clusters. In the realm of cluster operation, continuously validating and optimizing the configuration relies on access to accurate cluster behavioral models. Network Digital Twins (NDTs) have emerged as a paradigm to provide such accurate, live representations of network systems. To capture the live state, NDTs need to anticipate the cluster behavior in a faster than real-time manner. With increasingly complex clusters, such as K8s, which have many components and parameters to tune, classical NDTs relying on detailed handcrafted simulators for tuning become too slow to fulfill this task. Leveraging measurements from the actual system demonstrates the potential to create more high-level, lightweight NDTs. Nonetheless, varying degrees of abstraction result in different accuracy and computational speed thereby resulting in uncertainty in developing data-driven NDTs.

### SUMMARY

In at least one embodiment, a method includes receiving, as input, data for lagged contexts of a predetermined context length of a microservices architecture. Based on the received data, output is predicted in an autoregressive manner for a selected prediction length using Machine Learning (ML). The microservices architecture is configured using the output.

In at least one embodiment, a centralized network digital twin is configured to receive, as input, data for lagged contexts of a predetermined context length of a microservices architecture. Based on the received data, output is predicted in an autoregressive manner for a selected prediction length using Machine Learning (ML). The microservices architecture is configured using the output.

In at least one embodiment, a non-transitory computer-readable media having computer-readable instructions stored thereon, which when executed perform operations including receiving, as input, data for lagged contexts of a predetermined context length of a microservices architecture. Based on the received data, output is predicted in an autoregressive manner for a selected prediction length using Machine Learning (ML) using the output to configure the microservices architecture is configured using the output.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates the range of the level of abstraction for the three modeling approaches according to at least one embodiment.

FIG. 2 illustrates a high-level architecture of a Kubernetes (K8) cluster according to at least one embodiment.

FIG. 3 illustrates the event chains and control mechanisms of a Handcrafted Simulator.

FIG. 4 illustrates a high-level Input/Output (I/O) view of a Handcrafted Simulator or a Decentralized Twin.

FIG. 5 illustrates a high-level Input/Output (I/O) view of a Centralized Twin according to at least one embodiment.

FIG. 6 illustrates the Centralized Twin inputs and outputs according to at least one embodiment.

FIG. 7 illustrates the Mean Absolute Error (MAE) of the Mean Request Completion Time (rct_mean) of the Centralized Twin with increasing prediction lengths according to at least one embodiment.

FIG. 8 illustrates parity plots for the three modeling approaches according to at least one embodiment.

FIGS. 9a-c illustrate the time evolution of rct_mean predictions of three models according to at least one embodiment.

FIGS. 10a-b illustrates multiple cluster runs of a 30 min segment from the Test Dataset according to at least one embodiment.

FIGS. 11a-c illustrates measurements of incoming data according to at least one embodiment.

FIGS. 12a-c shows the dependencies on the incoming request pattern according to at least one embodiment.

FIG. 13 is a flowchart of a method for providing a Centralized Network Digital Twin for a microservices architecture according to at least one embodiment.

FIG. 14 illustrates an embodiment of a device.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

The following disclosure provides illustration and description but is not intended to be exhaustive or to limit the implementations to the precise form disclosed. Modifications and variations are possible in light of the above disclosure or may be acquired from practice of the implementations.

In at least one embodiment, a method includes receiving, as input, data for lagged contexts of a predetermined context length of a microservices architecture. Based on the received data, output is predicted in an autoregressive manner for a selected prediction length using Machine Learning (ML). The microservices architecture is configured using the output.

Embodiments described herein provide method that provides one or more advantages. For example, a black box approach of the Centralized Twin using Machine Learning (ML) powered model of the Kubernetes cluster achieves higher accuracies and lower runtimes. The configuration of the Kubernetes cluster is optimized. By providing a fast and accurate model, testing is able to be improved so that “what if scenarios” are tested using different configurations. Different configurations are able to be input and the outcome is able to be tested so that the response of the system (e.g., the Kubernetes cluster) is identified. Based on determining the response of the system to the different configurations, the optimal configuration is able to be applied to the cluster.

In today's cloud environments, Kubernetes (K8s) has become the de-facto standard for managing microservice-based containerized architectures. The flexibility and high configurability of K8s are among the main drivers for its wide adoption. K8s gives access to a high number of parameters for performance tuning.

Nondeterministic Polynomial Time (NP) is a fundamental concept in computational theory and complexity science. NP refers to a class of decision problems for which a “yes” solution can be verified in polynomial time. Deciding how to conduct cluster tuning is an NP-hard optimization task, and using heuristics relies on knowledge of the present state and future cluster evolution. Currently, cluster operators provide this knowledge, but as the clusters grow in complexity and size, this approach becomes limiting.

A solution to address this challenge is represented by accurate, faster-than-real-time network performance models. Network performance models facilitate investigating “What-If” scenarios and validating configurations without disrupting the real system. Tailored to the networking domain, Network Digital Twins (NDTs) have emerged as a method to create accurate models of microservice architectures, communication networks and the like. To capture the network's underlying behavior, NDTs leverage detailed cluster representations in the form of a handcrafted rule-based Discrete Event Simulator (DES). However, in complex systems, such as K8s, which have many components and parameters to tune, a high-fidelity DES that is able to capture detail of the actual system dramatically slows down NDT predictions.

Slowing NDT predictions limits the applicability of NDTs to short time-scale predictions. Additionally, such a rule-based DES also has the disadvantage of requiring a high coding effort, wherein a rule-based DES has to be manually revisited with any changes in the system, including the underlying software and infrastructure. Moreover, failure to capture specific behaviors of the system components decreases the modeling quality, making this approach error-prone.

Data-driven models display higher flexibility and lower computational runtime, reaching comparable prediction accuracy. Working with a higher level of abstraction, Machine Learning (ML) has been shown to accurately capture network behavior and aid in downstream tasks, such as latency and Quality-of-Service (QOS) prediction. Moving towards the application layer, data-driven NDTs have been used to model K8s components. While ML can enhance network models, uncertainty remains in whether modeling such clusters is able to rely on component-wise modeling or whether Black Box approaches suffice. Depending on the abstraction level, the performance models are subject to different accuracy and computational speed.

In the context of Software-Defined Networking, data-driven methods have been demonstrated to reduce computational complexity for performance prediction tasks while keeping a comparable performance level. Such twinning methods map traffic matrices and configurations to metrics such as End-to-End (E2E) delays and Quality of Service (QOS) levels. However, such data-driven methods still suffer from the above problems.

Digital Twins of K8s have relied mostly on Handcrafted rule-based DES. Handcrafted rule-based DES implement the behavior of the Kubernetes components, similarly to a Handcrafted Simulator. Still Handcrafted rule-based DES still suffer from scalability limitations, as described herein. KubeTwin is the closest model to the Handcrafted Simulator discussed herein, wherein the K8s LB, HPA, and Pod Scheduling functions are implemented using rule-based models.

KubeKlone and Kapetanios provide general frameworks for creating data-driven Kubernetes Digital Twins for single- and multi-service clusters. However, past prototypes of K8s Twins do not offer an in-depth comparison of how different abstraction levels impact the performance of these Twins. Thus, such K8s Twins still suffer from the above problems.

The chosen modeling abstraction level on the final model performance in the context of data-driven modeling impacts framework orchestration and other aspects of networks. To create a performance model of the Kubernetes cluster, for example, to capture the live state of a network system, network digital tools are to be accurate and are to anticipate the cluster behavior in a faster than real time manner. Herein, three approaches for twinning K8s that exploit different levels of knowledge about the system's inner workings are described: a Handcrafted Simulator, a Decentralized Twin, and a Centralized Twin. Those skilled in the art are able to recognize that the models described herein are applicable to other orchestrating frameworks, and that Kubernetes is presented as one example. Further, Network Digital Twins, including the Centralized Twin described herein, are applicable to other types of networks, such as the 5G core network or to other microservice-based architectures.

According to at least one embodiment, the network configuration for a cluster is optimized. A Centralized Twin model is used to test different configurations of the system (e.g., the Kubernetes cluster), and then the best or optimized configuration is implemented, wherein operation of the selected configuration is known before the configuration is deployed. Negative impacts on an application resulting from a sub optimal configuration are thus reduced and different scenarios are able to be investigated.

In response to some parameters of the system changing, the model is retrained on the observations of the measurements. The system or the model is not revised in order to be on the same level as the real system. Additionally, a data-driven model also has the advantage of capturing some behaviors that Handcrafted Simulators do not consider. Machine Learning (ML) works really well for network performance modeling for downstream tasks such as latency prediction or quality of service prediction.

However, as described in more detail below, the abstraction level of a modeling approach, such as data-driven modeling approaches, is analyzed for providing an accurate depiction of the system. The abstraction level of a modeling approach is able to involve individually modeling the components with data-driven methods or a black box approach where the system (e.g., the Kubernetes cluster or other microservices architecture) is observed globally without explicit information about individual K8s components. Depending on the abstraction level that is chosen, corresponding performance models are subject to different accuracies and computational speeds. The Centralized Twin implements the Black Box approach where the dependencies between input variables (such as incoming request patterns) are learned and Key Performance Metrics (KPMs) are provided as output. As described herein, the Centralized Twin performs better than a Decentralized Twin in terms of accuracy and speed.

A centralized network digital twin for a microservices architecture, such as a Kubernetes cluster, is configured to receive, as input, data for lagged contexts of a predetermined context length of a microservices architecture. The received data includes at least one of Request Completion Times (RCT) statistics, Requests Per Second (RPS), or a Number of Pods having a predetermined granularity and wherein the output includes a prediction of one or more of Request Completion Times (RCT) statistics, Requests Per Second (RPS), or the Number of Pods corresponding to a next prediction length interval. The Request Completion Times (RCT) statistics includes at least one of a mean RCT value, a minimum RCT value, a maximum RCT value, or a median RCT value aggregated for every second. According to at least one embodiment, for a subsequent prediction length, the at least one of the Request Completion Times (RCT) statistics, the Requests Per Second (RPS), or the Number of Pods is replaced with measured values. According to at least one embodiment, for a subsequent prediction, the RPS is replaced with a measured RPS value, the number of pods is dropped, and a context window is shifted by one so that new RCT inputs incorporate a last prediction. Based on the received data, output is predicted in an autoregressive manner for a selected prediction length using Machine Learning (ML). The output is predicted iteratively to obtain a prediction for a total test duration. Further, the output is predicted in the autoregressive manner using a black box approach using data-driven Machine Learning (ML) modeling based on measurements to learn dependencies between the input and Key Performance Metrics (KPMs). The microservices architecture is then configured using the output. The configuration of the Kubernetes cluster is optimized. By providing a fast and accurate model, testing is able to be improved so that “what if scenarios” are tested using different configurations. Different configurations are able to be input and the outcome is able to be tested so that the response of the system is identified. Based on determining the response of the system to the different configurations, the optimal configuration is able to be applied to the cluster.

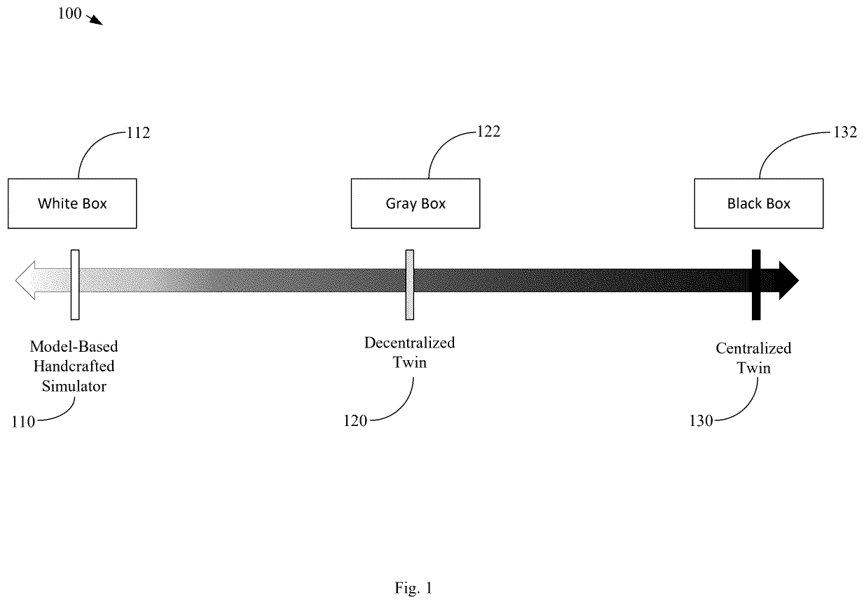

FIG. 1 illustrates the range of the level of abstraction for the three modeling approaches 100 according to at least one embodiment.

In FIG. 1, the Handcrafted Simulator 110 provides a request-level model-based DES of K8s, i.e., White Box approach 112. In the White Box approach 112, components are individually modelled and where components from the real running algorithms are used in the Handcrafted Rule Based Discrete Events Simulators (DES) 110. In contrast, the Decentralized Twin 120 and the Centralized Twin 130 are data-driven and leverage measurements.

The Decentralized Twin 120 extends the Handcrafted Simulator 110 and replaces the K8s major components with ML models derived from measurements of the actual behavior of components, i.e., a Gray Box approach 122. In the Gray Box approach 122 of the Decentralized Twin 120, the individual components of the Kubernetes cluster are modeled using machine learning counterparts.

The Centralized Twin 130 follows a Black Box approach 132 where the incoming request patterns of the system, and some monitoring data are received. Machine Learning is applied to generate outputs of the KPMs that are fed back in into the system. By observing the system globally and without explicit information about the individual K8s components, the Centralized Twin 130 learns the dependencies between input variables (such as incoming request patterns) and provides as output Key Performance Metrics (KPMs).

The goal of models is to learn the system behavior and accurately map the Incoming Request Pattern and other model-specific inputs to the cluster KPMs. Accordingly, the Handcrafted Rule Based Discrete Events Simulators (DES) 110 and the Decentralized Twin 120 receive as input an incoming request pattern, e.g., the user load that is sent to the system, and static configuration data. The output is the Request Completion Time statistics, e.g., the time that is used by a request to be processed, and the number of pods. The number of pods correspond to the resources that are allocated to the application because Kubernetes allows for scaling up or down the resources based on usage. For more incoming requests, a higher CPU utilization is generated and, based on that, Kubernetes determines how to scale up.

The Centralized Twin 130 receives the incoming request pattern that has information about the request, such as application time statistics which are obtained from monitoring the cluster. However, this is an optional input because a prediction looking at a 10 hour time span is able to be used. A window looking 10 hours into the future is able to be used without feeding autoregressively the Request Completion Time (RCT) statistics. The incoming request pattern is able to be used to derive reasonable outputs for the RCT statistics and the number of pods.

Accordingly, the K8s cluster is able to be modeled using the three modeling approaches, e.g., the Handcrafted Simulator 110, the Decentralized Twin 120, and the Centralized Twin 130. The system modeling aspects involve consideration of decoupling system modeling from incoming Requests Per Second (RPS) pattern modeling, limitations of the Handcrafted Simulator 110 and the Decentralized Twin 120, and the limitation of the Centralized Twin 130.

Because of the nature of the simulator-based models of the Handcrafted Simulator 110 and the Decentralized Twin 120, and because of the chosen autoregressive prediction method for the Centralized Twin 130, modeling approaches described herein assume a good forecast of the future incoming request pattern. The incoming RPS pattern strictly depends on the user behavior. RPS pattern modeling is a factor that is independent of the K8s system modeling.

From the modeling perspective, the model of the Handcrafted Simulator 110 ignores delays such as a Pod's start-up time and the Load Balancer's time to discover and label a Pod as healthy. From the modeling execution speed perspective, because of the high interdependency between the simulated events, parallelization involves running several instances with different configurations. However, running several instances with different configurations does not decrease the time-to-result.

Because of the autoregressive nature, the Centralized Twin 130 makes sequential predictions. Despite being orders of magnitude faster than real-time in experiments, more complex microservices architectures increase model runtime. In such scenarios, the prediction is able to be accelerated at the cost of coarser aggregation of the input variables to thereby decrease the time resolution.

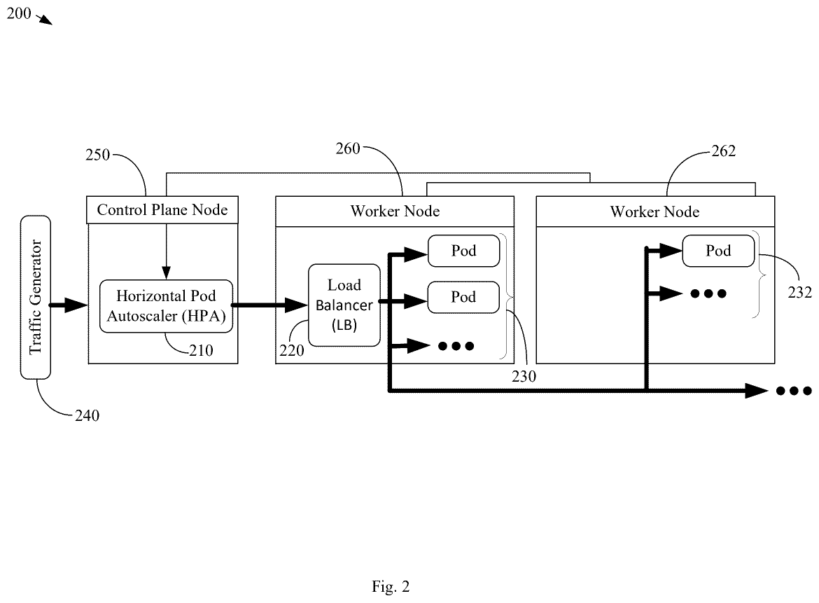

FIG. 2 illustrates a high-level architecture of a Kubernetes (K8s) cluster 200 according to at least one embodiment.

In FIG. 2, the K8s cluster has multiple components that are relevant to the modeling process, e.g., the Horizontal Pod Autoscaler (HPA) 210, the Load Balancer (LB) 220, and the Pods 230, 232 running the application. According to at least one embodiment, a high-level architecture of a Kubernetes (K8s) cluster involves a five-node K8s cluster with a Flannel Container Network Interface (CNI) Plugin. Flannel implements the CNI to enable pod networking in a Kubernetes cluster.

A Traffic Generator 240 resides outside the K8s cluster and generates traffic towards the application in the form of, for example, HTTP requests. A cluster has one Control Plane Node 250 that serves as an ingress point for the incoming HTTP requests and one or more Worker Nodes 260, 262. According to at least one embodiment, the nodes are implemented as Ubuntu 20.04 Virtual Machines (8 vCPUs, 8 GiB RAM, Kernel Version 5.4.0). The Control Plane Node 260 includes a Horizontal Pod Autoscaler (HPA) 210. The HPA 210 is the implementation of the K8s autoscaling feature. The HPA 210 allows the dynamic adaptation of the number of Pods 230, 232 inside a deployment, depending on the resource utilization induced by the incoming traffic. According to at least one embodiment, the K8s Horizontal Pod Autoscaler (HPA) 210 is configured to scale between 2 and 15 Pods 230, 232. Because the application is CPU-bound, the used scaling metric is CPU utilization, with a threshold of 60%. The remaining parameters of the HPA 210, including the stabilization windows for scale-in and scale-out, are configured with their default values.

FIG. 2 also shows Worker Nodes 260, 262 that run containerized applications. Every cluster has at least one Worker Node 260, 262. The Worker Node(s) 260, 262 host the Pods 230, 232 that are the components of the application workload. The Control Plane Node 250 manages the Worker Nodes 260, 262 and the Pods 230, 232 in the cluster. The Control Plane Node 250 is able to be implemented across multiple computers and a cluster usually runs multiple nodes, providing fault-tolerance and high availability.

A first Worker Node 260 includes Load Balancer (LB) 220. The LB 220 is responsible for distributing the incoming user traffic to the backend Pods 230, 232. According to at least one embodiment, the algorithm of the LB 220 is a round-robin process. In an alternative embodiment, the LB 220 is able to account for specific cluster metrics. Thus, the LB 220 decides where each request is to be forwarded so that the Pods 230, 232 have a similar resource consumption.

As shown in FIG. 2, the Worker Nodes 260, 262 include one or more Pods 230, 232. Pods 230, 232 are the smallest unit of K8s, which run a containerized application. To facilitate their management, Pods 230, 232 using the same underlying container images are grouped in deployments. According to at least one embodiment, an NGINX Ingress Controller is used by the cluster, wherein the NGINX Ingress Controller runs Peak EWMA Load Balancing to balance incoming requests among the available Pods 230, 232 based on the historic RCTs. Further, according to at least one embodiment, the application running inside the Pods 230, 232 is a Gunicorn HTTP server with a compute-intensive application. The application resembles, on an abstract level, a stateless function from the use-case of serverless computing. According to one example configuration, requests use 1000 mCPUs for 100 ms and runs in a single-threaded manner. While Gunicorn+Flask systems are able to support multithreading and are able to process more requests simultaneously, a configuration is chosen to ensure result comparability with the Handcrafted Simulator, but does not simulate the Linux CFS Scheduler and multithreading inside Pods 230, 232.

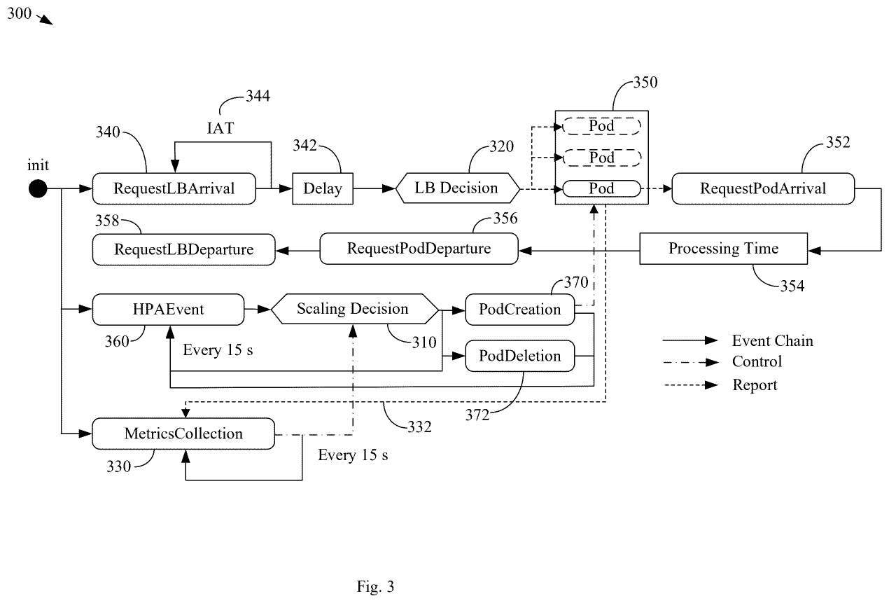

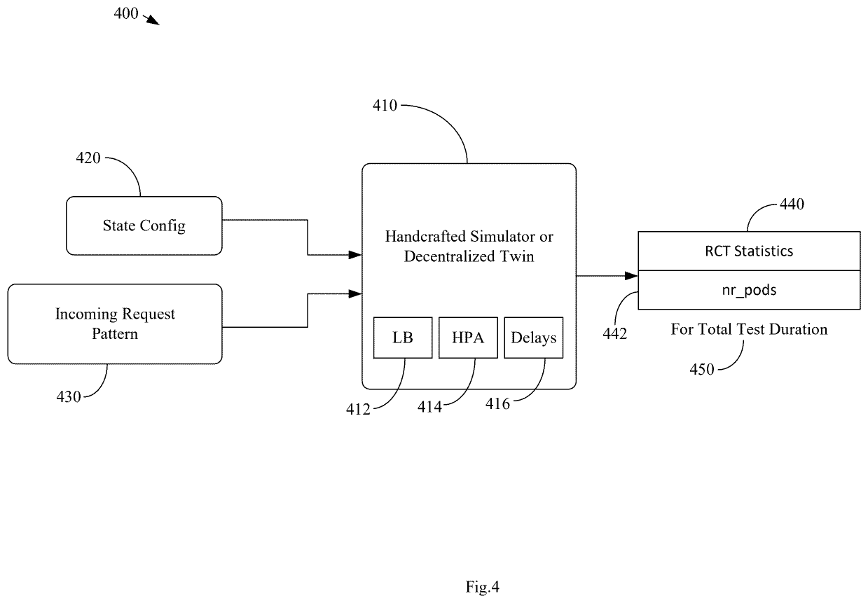

FIG. 3 illustrates the event chains and control mechanisms of a Handcrafted Simulator 300.

In FIG. 3, the logic governing the Handcrafted Simulator 300 is shown, which accommodates replaying request patterns in the form of cluster traces. The Handcrafted Simulator 300 serves as a baseline for comparing the data-driven models, is an internally developed request-level Discrete Event Simulator (DES). For example, the Handcrafted Simulator/DES is able to be programmed using Python. The DES implements models for the K8s components (Pods, LB, HPA, and Metrics Server).

The Handcrafted Simulator 300 includes the Scaling Decision 310, Load Balancing (LB) Decision 320, and Metric Collection 330. The simulator generates requests and RequestLBArrival events 340 based on the measured Inter-Arrival Times (IAT) 344. A Delay 342 is injected between RequestLBArrival events 340 and the LB Decision 320. The requests are forwarded to the LB Decision 320. The LB Decision 320 decides which Pod 350 will process the request. Upon arrival at a Pod 350, the requests are queued and generate RequestPodArrival events 352. The requests are completed after the Processing Time 354, generating a RequestPodDeparture 356 and finally a RequestLBDeparture 358.

In parallel to this event chain, two other event chains are executed in the Handcrafted Simulator 300. The first simulates the Metric Collection 330 that collects the CPU utilization 332 from the simulated Pods 350 every 15 seconds(s). The CPU utilization 332 is then used by the second event chain, which creates periodic HPA Events 360 that are used to scale the application by generating PodCreation events 370 and Pod-Deletion events 372. The PodCreation events 370 and Pod-Deletion events 372 impact the existing number of Pods 350 and future Load Balancing decisions 320. The Scaling Decision 310 creates pods, deletes pods, or does nothing.

A Metrics Server is a component used for the Metrics Collection 330 to collect and aggregate Node- and Pod-level metrics. The data provided by the Metrics Server for Metrics Collection 330 are used by the HPA to decide on scaling a deployment. The Metric Collection 330 is responsible for collecting the metrics from the Pods 350 and then sending them to the Scaling Decision 310. The Scaling Decision 310 decides whether to scale up or scale down the number of Pods 350, which is the default behavior of Kubernetes. As shown in FIG. 3, the Handcrafted Simulator 300 includes some delays including Delay 342 and Processing Time 354. The Processing Time 354 is based on how long the request is to be processed in the application and Delay 342 represents an inherent delay of the system.

Measurements are used to model the Delays, e.g., Delay 342 between the Control Plane Node of the cluster receiving the RequestLBArrival 340 and the Load Balancer 320, between the Load Balancer and the Pods (not shown), as well as the Processing Time 354. The Processing Time 354 is the time spent by a request inside a Pod 350, excluding queueing time. Because of the existing correlation between delays and the incoming number of requests, according to at least one embodiment, the delays are modeled as random variables following a Kernel Density Estimation (KDE) empirical distribution.

To implement a Decentralized Twin, three components of the Handcrafted Simulator 300 shown in FIG. 3 take on a data-driven approach where the handcrafted components of the Handcrafted Simulator are replaced by the data-driven counterparts.

FIG. 4 illustrates a high-level Input/Output (I/O) view 400 of a Handcrafted Simulator or a Decentralized Twin.

In FIG. 4, a Handcrafted Simulator or a Decentralized Twin 410 receives as input Static Configuration data 420 of the system and Incoming Request Patterns 430. In the Handcrafted Simulator, components are individually modelled. In the Decentralized Twin, the individual components of the Handcrafted Simulator, such as the Load Balancer (LB) 412, Horizontal Pod Autoscaler (HPA) 414, and the Unaccounted Delays or Latencies 416, are modeled using data-driven Machine Learning (ML). The models are derived based on the data measured from the system. For example, the Load Balancer 412 analyzes the incoming request to determine how to perform load balancing to provide high accuracy in determining the number of pods that are used. A Convolutional Neural Network (CNN) is able to be used based on the incoming request pattern, which maps to the number of running pods. Delays 416 are modeled as a random variable and sampled from this empirical distribution.

The data-driven modeling of a Load Balancer 412 for a Decentralized Twin is based on Machine Learning (ML) modeling for Load Balancing as a Network Function. According to at least one embodiment, a Multi-Layer Perceptron with three layers, ten neurons per layer, and a ReLU activation function is used to learn how the Incoming Request Pattern 430 maps to the internal score used by the Load Balancing algorithm to rank the Pods. To learn the behavior of the HPA 414, the CNN model is used to map the Incoming Request Pattern 430 to the number of running Pods. The CNN model is responsible for setting the new number of replicas, but the scaling events are scheduled every 15 s according to the K8s default configuration of the HPA 414.

Both the Handcrafted Simulator and the Decentralized Twin attempt to accurately map the Static Configuration parameters 420 and the Incoming Requests Pattern 430 to output KPMs, such as the Request Completion Time (RCT) statistics 440 and the number of Pods (nr_pods) 442 for Total Test Duration 450.

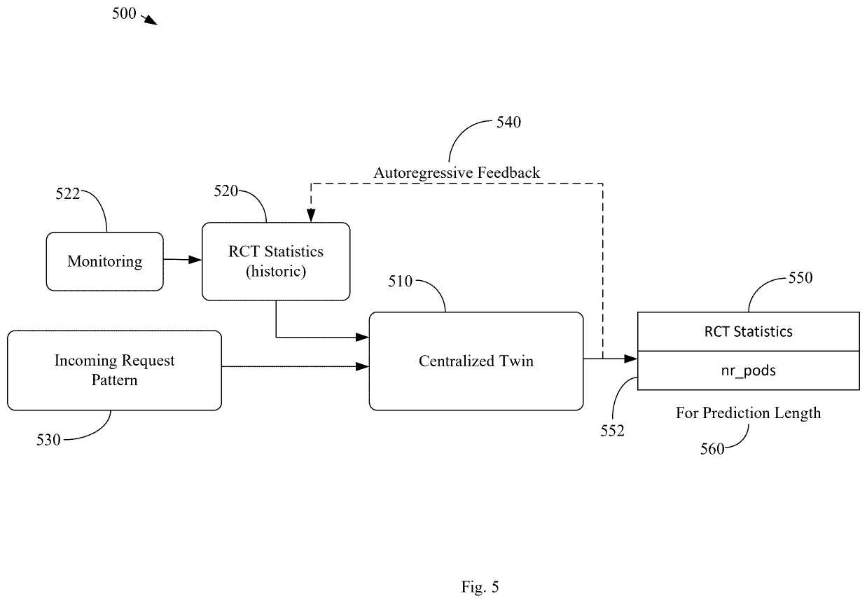

FIG. 5 illustrates a high-level Input/Output (I/O) view 500 of a Centralized Twin according to at least one embodiment.

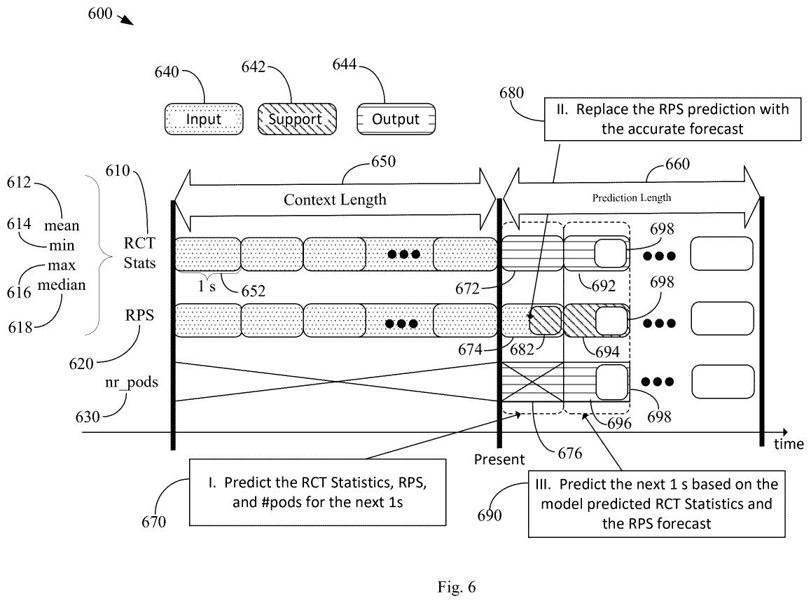

The Centralized Twin 510 is a Black Box model where the RCT Statistics 420 and Incoming Request Pattern 530 are provided as inputs. The RCT Statistics 420 are obtained from Monitoring 522. The Centralized Twin 510 receives RCT Statistics 520 and the Incoming Request Pattern 530. The Centralized Twin 530 uses Autoregressive Feedback 540 to predict output. The output includes the predicted RCT statistics 550 and number of pods (nr_pods) 552 for the selected Prediction Length 560. The input/output of the Centralized Twin 510 according to at least one embodiment are described in more detail in FIG. 6.

FIG. 6 illustrates the Centralized Twin inputs and outputs 600 according to at least one embodiment.

As shown in FIG. 6, at least one of Request Completion Time (RCT) Statistics 610, incoming Requests Per Second (RPS) 620, or a number of pods (nr_pods) 630 are provided as input 640. The RCT Statistics 610 include at least one of a mean RCT 612, minimum RCT 614, maximum RCT 616, and a median RCT 618 granularity of the past completion times. The RCT Statistics 610 provide a Context Length 650. The values have a granularity of one second 642. One context that is chosen is 300 seconds. According to at least one embodiment, the model used for the Centralized Twin is based on Lag-Llama, which is a Time Series Forecasting (TSF) ML model using, for example, a transformer-based decoder-only architecture. Lag-Llama has exhibited proven versatility over heterogeneous datasets and its potential as a foundation model. Leg-Llama provides good results on a heterogeneous time series data set. The Centralized Twin models the cluster by predicting the future K8s KPMs without relying on a simulator. The Centralized Twin uses Lag-Llama to predict univariate probability distributions for future timesteps. Based on the Llama architecture, Lag-Llama increases the prediction accuracy by adding time-lagged series of the target variable as input covariates.

However, the original univariate Lag-Llama cannot support the Centralized Twin approach with multivariate inputs and outputs. To accommodate multivariate time series, the Lag-Llama architecture is adapted to use the pre-embedding input flattening. By applying “spatiotemporal” embedding on the input, the attention heads, which is a technique used by AI models to focus on specific parts of an input sequence when making a prediction, the graph-like dependencies between the variables in the multivariate time series are learned.

Another adaptation of the Lag-Lama model involves removing the last layer. In the original Lag-Llama, the last layer outputs a probability distribution parameterized by the layer's input parameters of the layer. The choice of the distribution forces restrictive assumptions about the variable prediction, and in the customized Lag-Llama, the last layer is removed to allow the model to predict the metrics of interest directly.

As shown in FIG. 6, according to at least one embodiment, the mean Request Completion Time (RCT) and the number of Pods are target variables, while the RPS is replaced after every prediction with the true value. The time series corresponds to the Number of Pods (nr_Pods), Requests Per Second (RPS), and Request Completion Times (RCT) statistics (mean, minimum, and maximum) aggregated for every second. According to at least one embodiment, the model receives as input lagged contexts of context_length=300 s, with a maximum lag of 1200 s of the RPS and RCT statistics. The outputs, corresponding to the next prediction_length interval, are predicted in an autoregressive manner for all input variables and, additionally, for the number of Pods.

The granularities of the Input again are one second 652 in the Context Length 650. At least one of the mean RCT, RPS, and number of pods for the next one second are predicted. Then, the Centralized Twin looks at a variable amount of time in the future. The variable amount of time in the future is able to be changed and, after one training period, in response to using a smaller or a longer Prediction Length 660, as long the correct values for the incoming request patterns are used, then accurate Output is able to be predicted, i.e., the mean RCT and the number of pods.

The modeling approach assumes knowledge about the (future) incoming traffic. As depicted in FIG. 6, the Centralized Twin predicts, at the First Step 670, the RCT Statistics 672, the future incoming RPS value 674, and the number of Pods 676 for the next 1 s time interval. For the following prediction, the RPS value is replaced, at the Second Step 680, by an accurate forecast 682, the number of Pods 676 is dropped, and the context window shifts by one so that the new RCT inputs incorporate the last prediction. By applying this prediction procedure iteratively, the model predicts for the whole Prediction Length 660. After one Prediction Length, the inputs are replaced with the monitored values, thereby reducing the effect of the compounding errors for the RCT statistics 672. The variable Prediction Length 660 tunes a trade-off: a higher Prediction Length 660 is more valuable, as it allows seeing further in the future, but can also deviate more from the truth.

As shown in FIG. 6, Support 642 is used in the training. Lag-Llama predicts every token as an output. The Support 642 represents variables that are used by the loss function of the model. Later on, the inference spaces are discarded and are not relevant. The inference spaces are used when the loss function is calculated. The Centralized Twin model, given at least one of RCP statistics 610, the RPS 620, or the number of pods 630, predicts the next values for the next token at the Third Step 690, e.g., the RCT statistics 692, the RPS 694, and the number of pods 696. Thus, the Output 644 of the model includes at least one of the RCT statistics 692, the RPS 694, or the number of pods 696. After this, the Support 642 is not used. The Support 642 is used during the training phase. In the inference phase, the Support output 642 is replaced by real inputs obtained from monitoring the traffic generator model. The idea is to separate the incoming request patterns from the system modeling per se. Thus, the Support 642 is replaced with an input that is obtained from the traffic generator model.

In FIG. 6, the White Areas 698 show that after the first second is predicted, then what occurs in the next second is unknown. As indicated in FIG. 6 at the First Step 670, the RCT Statistics 672, the RPS 674, and the number of Pods 676 for the next 1 second is predicted. The prediction from the first second is used to predict the next second. The first half is shown filled which represents an intermediate stage. According to the Second Step 680, the RPS prediction 674 in the first 1 second is replaced with an accurate forecast 682. The Third Step 690 is to predict the next one second. An auto regressive loop is where the model predicts something and this is fed into back into the model for the next prediction. Thus, the output is predicted in the autoregressive manner by a black box approach using data-driven Machine Learning (ML) modeling based on measurements to learn dependencies between the input and Key Performance Metrics (KPMs). The next 1 second is based on the model-predicted RCT Statistics 672 and the RPS forecast 674.

The black box approach of the Centralized Twin using the Machine Learning (ML) powered model of the Kubernetes cluster achieves higher accuracies and lower runtimes. The configuration of the Kubernetes cluster is optimized. By providing a fast and accurate model, testing is able to be improved so that “what if scenarios” are tested using different configurations. Different configurations are able to be input and the outcome is able to be tested so that the response of the system is identified. Based on determining the response of the system to the different configurations, the optimal configuration is able to be applied to the cluster.

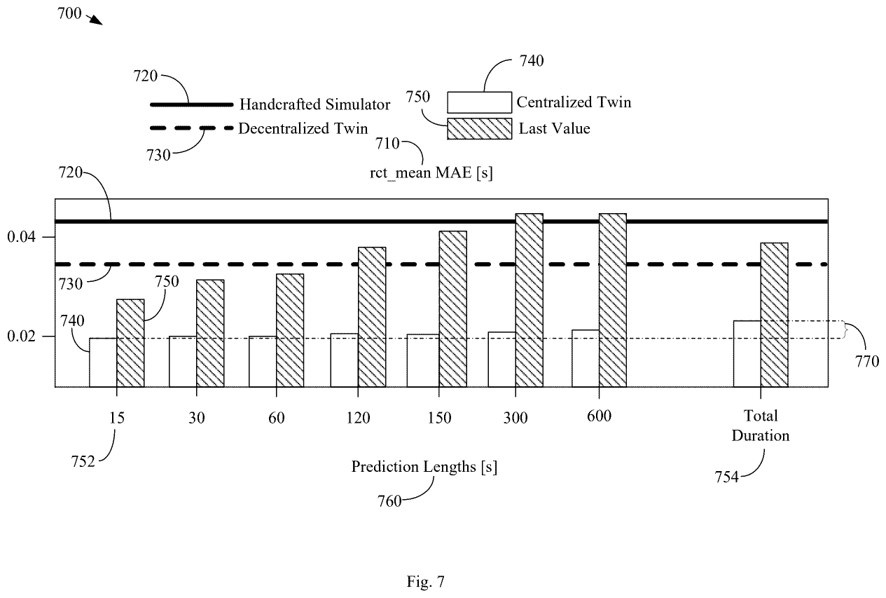

FIG. 7 illustrates the MAE of the rct_mean 700 of the Centralized Twin 740 with increasing prediction lengths according to at least one embodiment.

In FIG. 7, the Mean Absolute Error (MAE) 710 of the rct_mean predictions for the Handcrafted Simulator 720, the Decentralized Twin 730, and the Centralized Twin 740 over the Test Dataset is shown for different Prediction Lengths 760, varying from 15 s 752 to the entire Test Duration 754. According to at least one embodiment, requests are generated using Apache Jmeter with the Throughput Shaper Timer and the Concurrency Thread Group. Data is collected for a time span of 72 h, comprising 14.06 million HTTP requests.

In FIG. 7 the Centralized Twin 740 is compared against the Handcrafted Simulator 720, the Decentralized Twin 730, and a baseline that outputs the Last Value 750. The Last Value of the rct_mean 750 is used to verify the net benefit of a more complex ML architecture to solve the prediction task. The Last Value 750 is used as proof that the model is actually learning, and the model is not just outputting the last values seen.

FIG. 7 shows that the MAE of the rct_mean of the Centralized Twin 740 increases only marginally 770. The MAE of the rct_mean of the Centralized Twin 740 outperforms the Handcrafted Simulator 720 and the Decentralized Twin 730 for all Prediction Lengths 760. Further, the Centralized Twin 740 outperforms the Handcrafted Simulator by 46-53% and the trivial Last Value Baseline 750 by 30-41%. Error exhibited by the Centralized Twin 740 only weakly increases with increasing Prediction Length 760. Accordingly, higher Prediction Lengths 760 only marginally affect the performance of the Centralized Twin. The Centralized Twin 740 is trained with a Prediction Lengths 760 of 15 s. However, because of the model's autoregressive capabilities, it can be used for larger Prediction Lengths 760 than those for which it was trained.

Therefore, FIG. 7 clearly shows that the Centralized Twin 740 outperforms the Handcrafted Simulator 720 and the Decentralized Twin 730. A more in-depth analysis of the three models shows the higher accuracy of the Centralized Twin 740 for the RCT prediction task.

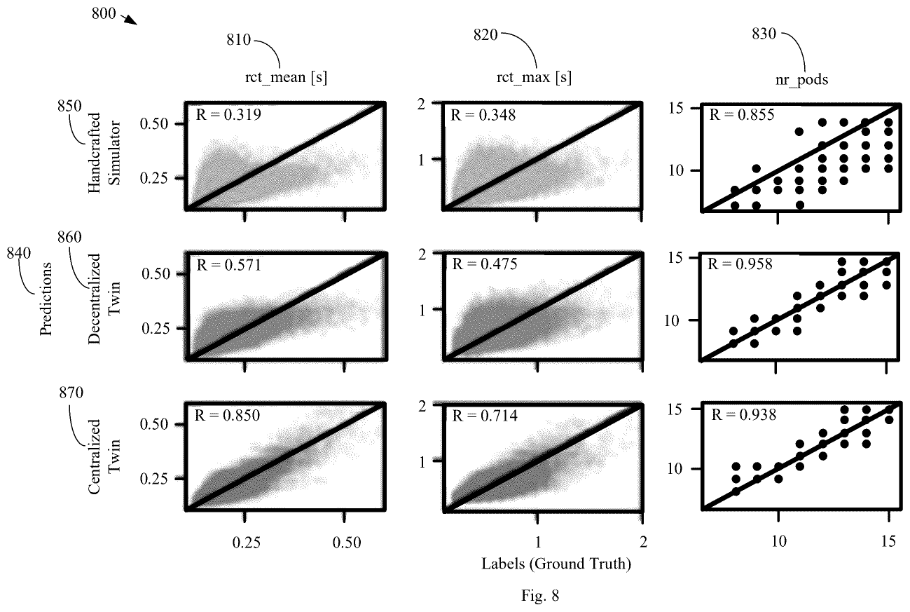

FIG. 8 illustrates parity plots for the three modeling approaches 800 according to at least one embodiment.

In FIG. 8, the rct_mean 810, rct_max 820, and the number of pods (nr_pods) 830 are shown for the Predictions 840 for the Handcrafted Simulator 850, the Decentralized Twin 860, and the Centralized Twin 870. The correlation coefficients (“R”) are higher for the Centralized Twin 870 than for the Handcrafted Simulator 850 and the Decentralized Twin 860. The Centralized Twin 870 with the maximum prediction_length reaches a higher correlation coefficient (“R”) for rct_mean 810 and rct_max 820. Additionally, the Centralized Twin 870 achieves an rct_mean MAE equal to 0.023, outperforming the MAE of the rct_mean of 0.043 for the Handcrafted Simulator 850 and the MAE of the rct_mean of 0.035 for the Decentralized Twin 860.

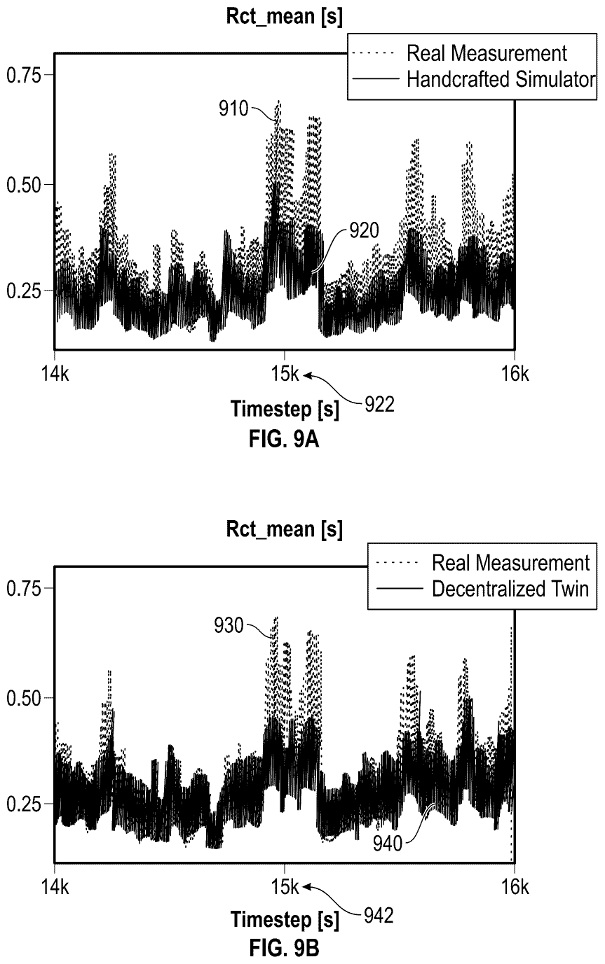

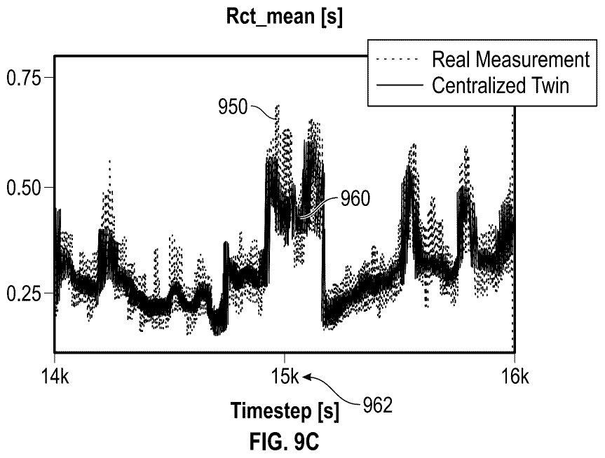

FIGS. 9a-c illustrate the time evolution of rct_mean predictions of three models according to at least one embodiment.

In FIG. 9a, the Real Measurement 910 is compared to the Handcrafted Simulator 920. In FIG. 9b, the Real Measurement 930 is compared to the Decentralized Twin 940. In FIG. 9c, the Real Measurement 950 is compared to the Centralized Twin 960. For example, at the time stamp around 15,000 962, the Centralized Twin 960 in FIG. 9c matches the Real Measurements 950 better than the Handcrafted Simulator 920 the time stamp around 15,000 942 matches the Real Measurement 910 in FIG. 9a and better than the Decentralized Twin 940 the time stamp around 15,000 922 matches the Real Measurement 930 in FIG. 9b.

Table 1 compares the different accuracy metrics for the variants of the Decentralized Twin, the Handcrafted Simulator, and the two variants of the Centralized Twin. In response to replacing specific components of the Handcrafted Simulator, e.g., Delays, Load Balancing, HPA, with data-driven counterparts, a difference in the in the Mean Absolute Error (MAE) is smaller in some implementations of the Decentralized Twin and is smaller in each of the representative Centralized Twins. For example, the Decentralized Twin with data-driven HPA shows an MAE of 0.037. The Decentralized Twin with data-driven Delays and HPA shows an MAE of 0.040. The Decentralized Twin with data-driven Delays, Load Balancing, and HPA shows an MAE of 0.035. Each of the these MAE's of the Decentralized Twin is lower than the MAE of the Handcrafted Simulator, which is 0.043. However, in the case for the Decentralized Twin where the Delays and the Load Balancing are data-driven, but the HPA is not, a higher MAE (0.056) is obtained. Thus, having these two components being data-driven actually does not improve performance, but actually worsens the performance. However, in other cases, having an accurate HPA, for instance, shows an improvement over the Handcrafted Simulator. From all the models analyzed, the Centralized Twin and the Decentralized Twin are compared to the empirical error lower bound for the RCT mean prediction.

TABLE 1

| | | | | rct_mean | | | | | nr_pods | | | | |
|---|---|---|---|---|---|---|---|---|---|---|---|---|---|
| | Data-Driven | | | | | | KS- | x² - | | DPH | Pod | Model | |
| Approach | Delays | LB | HPA | MAE | RMSE | R-Score | Stats | Stats | MAE | (%) | Events | Runtime | |
| Simulator | — | — | — | 0.043 | 0.060 | 0.319 | 0.081 | 0.085 | 1.400 | −10.4 | 226 | 3.55 | h |
| Decentralized | ✓ | — | — | 0.045 | 0.057 | 0.420 | 0.173 | 0.193 | 1.149 | −8.4 | 227 | 7.60 | h |
| Twin | — | ✓ | — | 0.052 | 0.070 | 0.246 | 0.315 | 0.657 | 1.403 | −10.4 | 222 | 21.24 | h |
| | — | — | ✓ | 0.037 | 0.053 | 0.659 | 0.305 | 0.985 | 0.274 | −0.4 | 101 | 3.10 | h |
| | ✓ | ✓ | — | 0.056 | 0.072 | 0.314 | 0.403 | 1.112 | 1.181 | −8.7 | 226 | 24.87 | h |
| | ✓ | — | ✓ | 0.040 | 0.043 | 0.469 | 0.127 | 0.089 | 0.274 | −0.4 | 101 | 5.82 | h |
| | ✓ | ✓ | ✓ | 0.035 | 0.049 | 0.571 | 0.152 | 0.172 | 0.274 | −0.4 | 101 | 24.19 | h |

| | | | | | | | | | | | |
|---|---|---|---|---|---|---|---|---|---|---|---|
| Centralized | pred_length = 15 s | 0.020 | 0.029 | 0.887 | 0.054 | 0.097 | 0.071 | −0.2 | N/A | 4.98 | min |
| Twin | pred_length = 38 655 s | 0.023 | 0.033 | 0.850 | 0.078 | 0.098 | 0.381 | 0.7 | N/A | 4.88 | min |

For the Decentralized Twin, turning on the ML-powered HPA leads to the highest individual improvement in the mean RCT modeling performance (14%). The ML-powered HPA model leads to 80% lower nr_Pods MAE and 96% more accurate PodHours prediction. Further, modeling the delays does not modify the error for predicting nr_Pods and slightly increases the error in the rct_mean prediction. An ML-learned Load Balancer reduces the MAE of the rct_mean by additionally 5%. The best Decentralized Twin is the one where components are data-driven and outperforms the Handcrafted Simulator by 19% for the MAE of the rct_mean and by 80% for the nr_pods MAE.

Replacing specific handcrafted components in the Decentralized Twin may reduce the model accuracy. Table 1 shows that an inaccurate handcrafted HPA model negatively interferes with the data-driven Load Balancer (LB). The data driven LB improves the Decentralized Twin in response to being coupled with an accurate prediction of the nr_pods, otherwise it decreases the performance predictions.

The Load Balancer model is trained on data originating from a system where the nr_Pods is accurate and relies on an accurate nr_pods to make the Load Balancing predictions. Although the training features correspond to one Pod and is independent of the nr_pods in the system, the learned LB model still shows implicit dependencies on the HPA model. A data-driven LB reduces the final accuracy for an inaccurate HPA, but the final accuracy increases when coupling the data-driven LB with an accurate HPA. Therefore, separating the component models and individually learning the functions is error-prone, if not all components are learned with data-driven models. The inherent variance of the system is able to be analyzed by rerunning a 45 min section from the 72 h trace 20 times. The first 15 min of the runs correspond to transient behavior and are discarded.

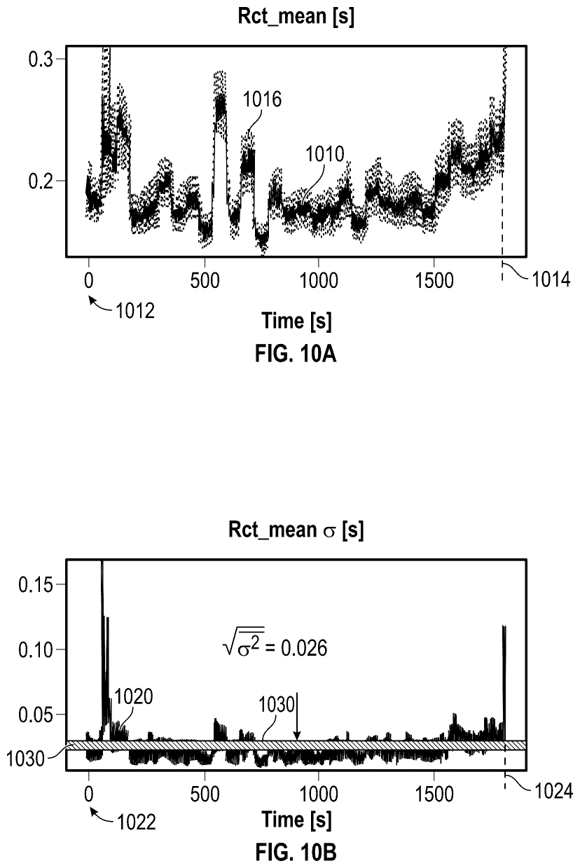

FIGS. 10a-b illustrates multiple cluster runs of a 30 min segment from the Test Dataset according to at least one embodiment.

FIG. 10a shows the evolution of the rct_mean prediction 1010 from 0 seconds 1012 to approximately 2000 seconds 1014 with 95% confidence intervals 1016.

FIG. 10b shows the prediction mean standard deviation (rct_mean σ) 1020 from 0 seconds 1022 to approximately 2000 seconds 1024. The empirical standard deviation 1030 is determined to be 0.026.

As seen in FIG. 10b, there is inherent variance for the same incoming request pattern and the empirical standard deviation represents an empirical lower bound for the best achievable Root Mean Squared Error (RMSE) prediction error. The RMSE for the Centralized Twins is within 12-27% of this empirical limit, while the best Decentralized Twin and the Handcrafted Simulator deviate from the empirical limit by 88% and 135%, respectively.

Referring again to Table 1, the Centralized Twin is presented with a 15 second prediction length and with an approximate 10.8 hour prediction length (36,655 seconds). As seen in Table 1, even with a high prediction length of about 10 hours into the future, the Centralized Twin model performs a bit worse, but is still better than the Handcrafted Simulator and the Decentralized Twin.

Also as seen in Table 1, the Centralized Twin provides the lowest Model Runtime of 4.98 minutes for a prediction length of 15 seconds and 4.88 minutes for a prediction length of 36,655 seconds. For the prediction length of 15 seconds, after every 15 seconds, the real data from the system is fed into the monitoring data and the prediction to make further predictions. So even though here the prediction length is 15 seconds, the prediction is across the whole time span of the 10.8 hours, but in chunks of 15 seconds.

Despite the Black Box view of the Centralized Twin, the Centralized Twin is more accurate and faster than the Handcrafted Simulator and the Decentralized Twin. The Centralized Twin is able to predict the system performance for a 10.8 h Test Dataset Duration in under 5 min. The Centralized Twin is 130× faster than real-time, 42× faster than the Handcrafted Simulator, and 290× faster than the fully data-driven Decentralized Twin.

For the Decentralized Twin, a data-driven HPA model consistently decreases the runtime compared to the handcrafted HPA. The more accurate data-driven HPA has a less variable number of Pods and generates fewer erroneous PodCreation and PodDeletion Events (Pod Events in Table 1). Despite the more complex scaling model, the data-driven HPA leads to fewer Pod Events, accelerating the simulation. On the other hand, because the data-driven DELAYS and LB are triggered for every request, the respective Decentralized Twins see an increase in the model runtime. Consequently, the full data driven Decentralized Twin is 2.23× slower than real-time. Thus, cluster operations are able to be improved using a Centralized Twin that uses a data-driven performance model to validate and optimize configurations. Further, the Centralized Twin outperforms the Handcrafted Simulator by 53% and the Decentralized Twin by 35%, while offering an execution speed-up of 130× over real-time. The Centralized Twin is able to model more sophisticated microservice architectures that also involve multithreaded Memory-bound, I/O-bound, or Network-bound processes. The architecture of the Centralized Twin is also able to be optimized through hyperparameter tuning and model pruning.

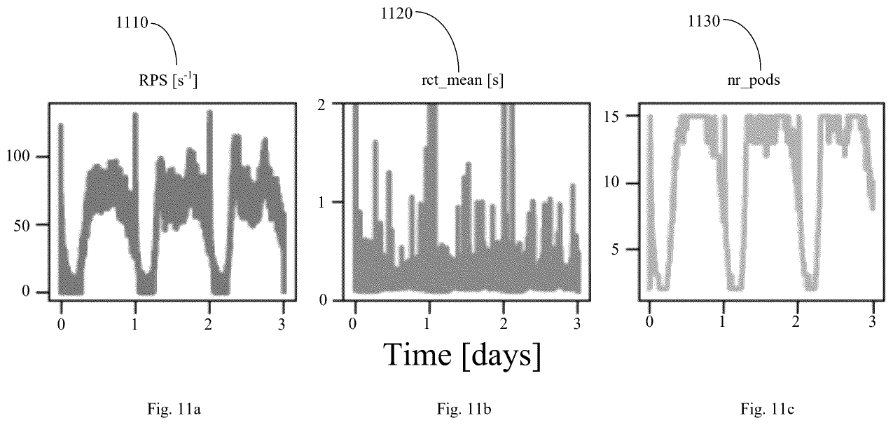

FIGS. 11a-c illustrates measurements of incoming data according to at least one embodiment.

In FIG. 11a, the incoming measurement is the incoming Request Per Second (RPS) pattern 1110. In FIG. 11b, the incoming measurement is the Request Completion Time mean (rct_mean) 1120. In FIG. 11c, the incoming measurement is the number of Pods (nr_pods) 1130.

For the incoming measurements shown in FIGS. 11a-c, the dataset is split based on time into transient/train/validation/test datasets (5/70/10/15%). The transient dataset is discarded from the training of the ML models. After that, the next 70% is used for training, and 10% for model selection during the training process. The test dataset comprises the last 10.8 h of the experiment and is used to calculate performance metrics results.

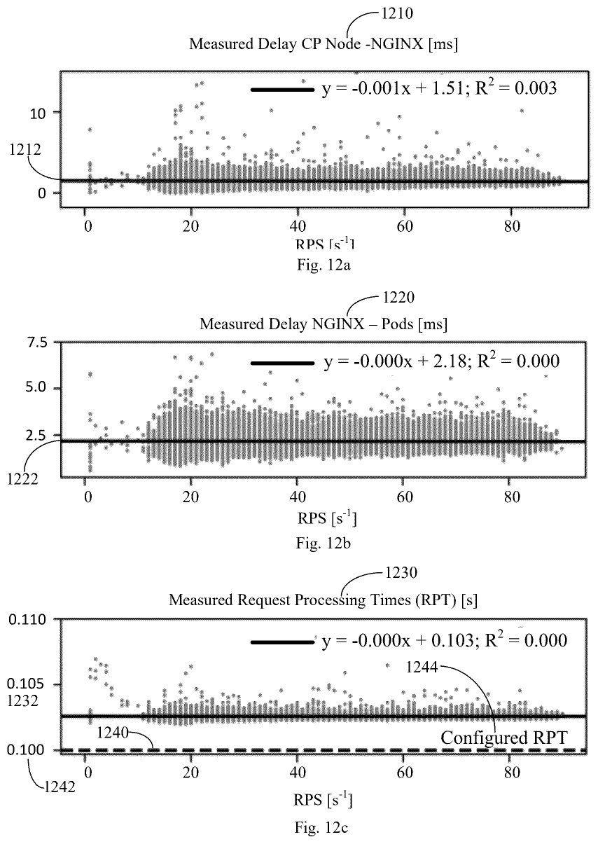

FIGS. 12a-c shows the dependencies on the incoming request pattern according to at least one embodiment.

In FIG. 12a, the dependency of the Measured Delay CP Node-NGINX 1210 on the incoming request pattern is shown. Line 1212 is y=1.51.

In FIG. 12b, the dependency of the Measured Delay NGINX-Pods 1220 on the incoming request pattern is shown. Line 1222 is y=2.18.

In FIG. 12c, the dependency of the Measured Request Processing Times (RPTs) 1230 on the incoming request pattern is shown. Line 1232 is y=−0.103. Line 1240 at 0.100 1242 represents the Configured RPT 1244.

Because the delays are independent of the number of incoming requests, the delays are able to be modeled as random variables.

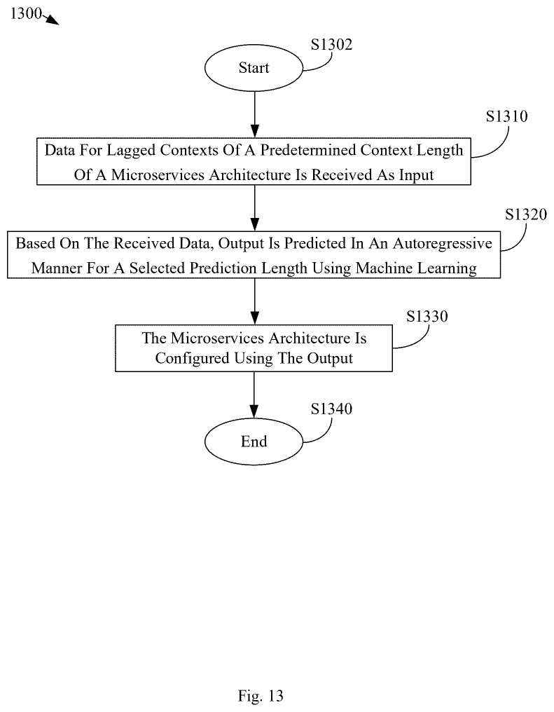

FIG. 13 is a flowchart 1300 of a method for providing a centralized network digital twin for a microservices architecture according to at least one embodiment.

In FIG. 13, the process starts S1302 and data for lagged contexts of a predetermined context length of a microservices architecture is received as input S1310. Referring to FIG. 6, at least one of Request Completion Time (RCT) Statistics 610, incoming Requests Per Second (RPS) 620, or a number of pods (nr_pods) 630 are provided as input 640. The RCT Statistics 610 include at least one of a mean RCT 612, minimum RCT 614, maximum RCT 616, and a median granularity 618 of the past completion times. The RCT Statistics 610 provide a Context Length 650. The values have a granularity of one second 642. One context that is chosen is 300 seconds. As shown in FIG. 6, according to at least one embodiment, the mean Request Completion Time (RCT) and the number of Pods are target variables, while the RPS is replaced after every prediction with the true value. The time series corresponds to the Number of Pods (nr_Pods), Requests Per Second (RPS), and Request Completion Times (RCT) statistics (mean, minimum, and maximum) aggregated for every second. According to at least one embodiment, the model receives as input lagged contexts of context_length=300 s, with a maximum lag of 1200 s of the RPS and RCT statistics.

Based on the received data, output is predicted in an autoregressive manner for a selected prediction length using machine learning $1320. Referring to FIG. 6, the outputs, corresponding to the next prediction_length interval, are predicted in an autoregressive manner for all input variables and, additionally, for the number of Pods. At least one of the mean RCT, RPS, or number of pods for the next one second are predicted. Then, the Centralized Twin looks at a variable amount of time in the future. The variable amount of time in the future is able to be changed and, after one training period, in response to using a smaller or a longer Prediction Length 660, as long the correct values for the incoming request patterns are used, then accurate Output is able to be predicted, i.e., the mean RCT and the number of pods. As depicted in FIG. 6, the Centralized Twin predicts, at the First Step 670, the RCT Statistics 672, the future incoming RPS value 674, and the number of Pods 676 for the next 1 s time interval. For the following prediction, the RPS value is replaced, at the Second Step 680, by an accurate forecast 682, the number of Pods 676 is dropped, and the context window shifts by one so that the new RCT inputs incorporate the last prediction. By applying this prediction procedure iteratively, the model predicts for the whole Prediction Length 660. After one Prediction Length, inputs are replaced with the monitored values, thereby reducing the effect of the compounding errors for the RCT statistics 672. The Centralized Twin model, given at least one of RCT statistics 610, the RPS 620, or the number of pods 630, predicts the next values for the next token at the Third Step 690, e.g., the RCT statistics 692, the RPS 694, and the number of pods 696. Thus, the Output 644 of the model includes at least one of the RCT statistics 692, the RPS 694, or the number of pods 696. As indicated in FIG. 6 at the First Step 670, the RCT Statistics 672, the RPS 674, and the number of Pods 676 for the next 1 second is predicted. The prediction from the first second is used to predict the next second. The first half is shown filled which represents an intermediate stage. According to the Second Step 680, the RPS prediction 674 in the first 1 second is replaced with an accurate forecast 682. The Third Step 690 is to predict the next one second. An auto regressive loop is where the model predicts something and this is fed into back into the model for the next prediction. Thus, the output is predicted in the autoregressive manner by a black box approach using data-driven Machine Learning (ML) modeling based on measurements to learn dependencies between the input and Key Performance Metrics (KPMs). The next 1 second is based on the model-predicted RCT Statistics 672 and the RPS forecast 674.

The microservices architecture is configured using the output S1330. Referring to FIG. 6, the black box approach of the Centralized Twin using the Machine Learning (ML) powered model of the Kubernetes cluster achieves higher accuracies and lower runtimes. The configuration of the Kubernetes cluster is optimized. By providing a fast and accurate model, testing is able to be improved so that “what if scenarios” are tested using different configurations. Different configurations are able to be input and the outcome is able to be tested so that the response of the system is identified. Based on determining the response of the system to the different configurations, the optimal configuration is able to be applied to the cluster.

The process then terminates S1340.

At least one embodiment of the method includes receiving, as input, data for lagged contexts of a predetermined context length of a microservices architecture. Based on the received data, output is predicted in an autoregressive manner for a selected prediction length using Machine Learning (ML). The microservices architecture is configured using the output.

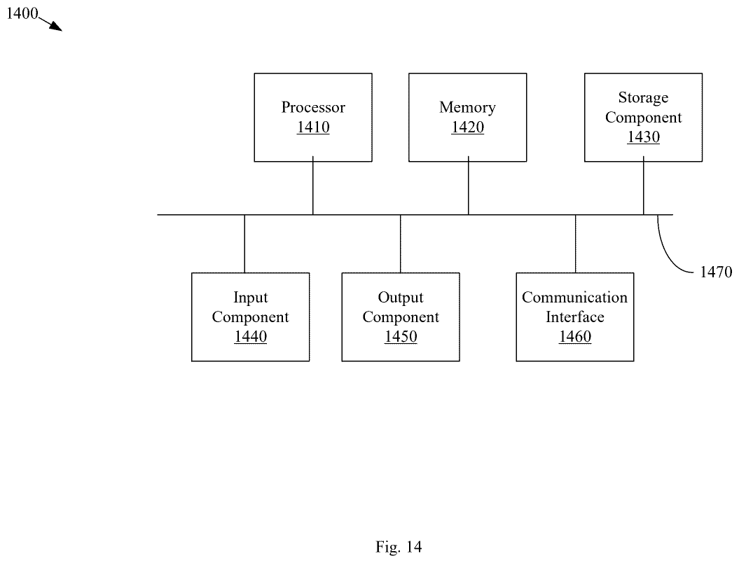

FIG. 14 illustrates an embodiment of a centralized network digital twin for a microservices architecture 1400. As shown in FIG. 14, the centralized network digital twin 1400 includes processor 1410, a memory 1420, a storage component 1430, an input component 1440, an output component 1450, a communication interface 1460, and a bus 1470.

The processor 1410, as used herein, means any type of computational circuit that may comprise hardware elements and software elements. The processor 1410 may be embodied as a multi-core processor, a single core processor, or a combination of one or more multi-core processors and/or one or more single core processors, a distributed processing system, or the like. The processor 1410 may be a Central Processing Unit (CPU), a graphics processing unit (GPU), an accelerated processing unit (APU), an application-specific integrated circuit (ASIC), or another type of processing component.

Memory 1420 includes a non-transitory computer readable medium. Memory 1420 includes a random-access memory (RAM), a read only memory (ROM), and/or another type of dynamic or static storage device (e.g., a flash memory, a magnetic memory, and/or an optical memory) that stores information and/or instructions for use by processor 1410. The memory 1420 comprises machine-readable instructions which are executable by the processor 1410. These machine-readable instructions when executed by the processor 1410 cause the processor 1410 to perform one or more method steps of an embodiment described above.

Storage component 1430 stores information and/or software related to the operation and use of the centralized network digital twin 1400. For example, storage component 1430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 1440 is configured to receive information, such as user input. For example, the input component 1440 may include, but not be limited to, a touch screen display, a keyboard, a keypad, a mouse, a button, a switch, and/or a microphone. Additionally, or alternatively, the input component 1440 may include a sensor for sensing information (e.g., a global positioning system (GPS), an accelerometer, a gyroscope, and/or an actuator).

Output component 1450 is configured to provide output information from the centralized network digital twin 1400. For example, the output component 1450 may be, but not limited to, a display, a speaker, an instruction device to an external device, and/or one or more light-emitting diodes (LEDs).

Communication interface 1460 is an interface that provides a communication connection to other devices, such as external devices and internal devices. The connection by the communication interface 1460 can be a wired connection, a wireless connection, or a combination of wired and wireless connections, and can be a direct connection or an indirect connection via a communication network that exists between the centralized network digital twin 1400 and other devices. In other words, the standard of the communication interface 1460 is not limited.

The bus 1470 acts as an interconnect between the processor 1410, the memory 1420, the storage component 1430, the input component 1440, the output component 1450, and the communication interface 1460 of the centralized network digital twin 1400. The bus 1470 may include a wired interconnection or a wireless interconnection.

The number and arrangement of components shown in FIG. 14 are provided as an example. In practice, centralized network digital twin 1400 may include additional components, fewer components, different components, or differently arranged components than those shown in FIG. 14. Additionally, or alternatively, a set of components (e.g., one or more components) of centralized network digital twin 1400 may perform one or more functions described as being performed by another set of components of centralized network digital twin 1400. Further, one or more method steps described in any of the embodiments may be performed utilizing a plurality of centralized network digital twin 1400 in communication with one another.

Embodiments described herein provide method that provides one or more advantages. For example, a black box approach of the Centralized Twin using Machine Learning (ML) powered model of the Kubernetes cluster achieves higher accuracies and lower runtimes. The configuration of the Kubernetes cluster is optimized. By providing a fast and accurate model, testing is able to be improved so that “what if scenarios” are tested using different configurations. Different configurations are able to be input and the outcome is able to be tested so that the response of the system is identified. Based on determining the response of the system to the different configurations, the optimal configuration is able to be applied to the cluster.

[1] An aspect of this description is directed to a method that includes receiving, as input, data for lagged contexts of a predetermined context length of a microservices architecture, based on the received data, predicting output in an autoregressive manner for a selected prediction length using Machine Learning (ML), and using the output to configure the microservices architecture.

[2] The method described in [1], wherein the receiving, as the input, the data includes receiving at least one of Request Completion Times (RCT) statistics, Requests Per Second (RPS), or a Number of Pods having a predetermined granularity and wherein the predicting the output includes predicting one or more of Request Completion Times (RCT) statistics, Requests Per Second (RPS), or a Number of Pods corresponding to a next prediction length interval

[3] The method described in [2], wherein the receiving the Request Completion Times (RCT) statistics includes receiving at least one of a mean RCT value, a minimum RCT value, a maximum RCT value, or a median RCT value aggregated for every second.

[4] The method described in [2] further comprising, for a subsequent prediction length, replacing the at least one of the Request Completion Times (RCT) statistics, the Requests Per Second (RPS), or the Number of Pods with measured values.

[5] The method described in [2] further comprising, for a subsequent prediction, replacing the RPS with a measured RPS value, dropping the number of pods, and shifting the context window by one so that new RCT inputs incorporate the last prediction.

[6] The method described in any of [1] to [5], wherein the predicting the output in the autoregressive manner includes predicting the output iteratively to obtain a prediction for a total test duration.

[7] The method described in any of [1] to [6], wherein the predicting the output in the autoregressive manner includes using a black box approach using data-driven Machine Learning (ML) modeling using measurements to learn dependencies between the input and Key Performance Metrics (KPMs).

[8] An aspect of this description is directed to a centralized network digital twin for a microservices architecture configured to receive, as input, data for lagged contexts of a predetermined context length of a microservices architecture, based on the received data, predict output in an autoregressive manner for a selected prediction length using Machine Learning (ML), and configure the microservices architecture using the output.

[9] The centralized network digital twin described in [8], wherein the data includes at least one of Request Completion Times (RCT) statistics, Requests Per Second (RPS), or a Number of Pods having a predetermined granularity and wherein the output includes a prediction of one or more of Request Completion Times (RCT) statistics, Requests Per Second (RPS), or a Number of Pods corresponding to a next prediction length interval.

[10] The centralized network digital twin described in [9], wherein the Request Completion Times (RCT) statistics includes at least one of a mean RCT value, a minimum RCT value, a maximum RCT value, or a median RCT value aggregated for every second.

The centralized network digital twin described in [9], wherein, for a subsequent prediction length, the at least one of the Request Completion Times (RCT) statistics, the Requests Per Second (RPS), or the Number of Pods is replaced with measured values.

The centralized network digital twin described in [9], wherein for a subsequent prediction, the RPS is replaced with a measured RPS value, the number of pods is dropped, and the context window is shifted by one so that new RCT inputs incorporate the last prediction.

The centralized network digital twin described in any of [8] to [12], wherein the output is predicted iteratively to obtain a prediction for a total test duration.

The centralized network digital twin described in any of [8] to [12], wherein the output is predicted in the autoregressive manner using a black box approach using data-driven Machine Learning (ML) modeling based on measurements to learn dependencies between the input and Key Performance Metrics (KPMs).

An aspect of this description is directed to a non-transitory computer-readable media having computer-readable instructions stored thereon, which when executed perform operations including receiving, as input, data for lagged contexts of a predetermined context length of a microservices architecture, based on the received data, predicting output in an autoregressive manner for a selected prediction length using Machine Learning (ML), and using the output to configure the microservices architecture.

The non-transitory computer-readable media described in [15], wherein the receiving, as the input, the data includes receiving at least one of Request Completion Times (RCT) statistics, Requests Per Second (RPS), or a Number of Pods having a predetermined granularity and wherein the predicting the output includes predicting one or more of Request Completion Times (RCT) statistics, Requests Per Second (RPS), or a Number of Pods corresponding to a next prediction length interval.

The non-transitory computer-readable media described in [16], wherein the receiving the Request Completion Times (RCT) statistics includes receiving at least one of a mean RCT value, a minimum RCT value, a maximum RCT value, or a median RCT value aggregated for every second.

The non-transitory computer-readable media described in further comprising, for a subsequent prediction length, replacing the at least one of the Request Completion Times (RCT) statistics, the Requests Per Second (RPS), or the Number of Pods with measured values.

The non-transitory computer-readable media described in further comprising, for a subsequent prediction, replacing the RPS with a measured RPS value, dropping the number of pods, and shifting the context window by one so that new RCT inputs incorporate the last prediction.

The non-transitory computer-readable media described in any of (15] to [19], wherein the predicting the output in the autoregressive manner includes using a black box approach using data-driven Machine Learning (ML) modeling using measurements to learn dependencies between the input and Key Performance Metrics (KPMs).

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for a centralized network digital twin for microservices applications, comprising:
receiving, as input, data for lagged contexts of a predetermined context length of a microservices architecture;
based on the received data, predicting output in an autoregressive manner for a selected prediction length using Machine Learning (ML); and
using the output to configure the microservices architecture.

2. The method of claim 1, wherein the receiving, as the input, the data includes receiving at least one of Request Completion Times (RCT) statistics, Requests Per Second (RPS), or a Number of Pods having a predetermined granularity and wherein the predicting the output includes predicting one or more of Request Completion Times (RCT) statistics, Requests Per Second (RPS), or the Number of Pods corresponding to a next prediction length interval.

3. The method of claim 2, wherein the receiving the Request Completion Times (RCT) statistics includes receiving at least one of a mean RCT value, a minimum RCT value, a maximum RCT value, or a median RCT value aggregated for every second.

4. The method of claim 2 further comprising, for a subsequent prediction length, replacing the at least one of the Request Completion Times (RCT) statistics, the Requests Per Second (RPS), or the Number of Pods with measured values.

5. The method of claim 2 further comprising, for a subsequent prediction, replacing the RPS with a measured RPS value, dropping the number of pods, and shifting a context window by one so that new RCT inputs incorporate a last prediction.

6. The method of claim 1, wherein the predicting the output in the autoregressive manner includes predicting the output iteratively to obtain a prediction for a total test duration.

7. The method of claim 1, wherein the predicting the output in the autoregressive manner includes using a black box approach using data-driven Machine Learning (ML) modeling using measurements to learn dependencies between the input and Key Performance Metrics (KPMs).

8. A centralized network digital twin for a microservices architecture configured to:
receive, as input, data for lagged contexts of a predetermined context length of a microservices architecture;
based on the received data, predict output in an autoregressive manner for a selected prediction length using Machine Learning (ML); and
configure the microservices architecture using the output.

9. The centralized network digital twin of claim 8, wherein the data includes at least one of Request Completion Times (RCT) statistics, Requests Per Second (RPS), or a Number of Pods having a predetermined granularity and wherein the output includes a prediction of one or more of Request Completion Times (RCT) statistics, Requests Per Second (RPS), or the Number of Pods corresponding to a next prediction length interval.

10. The centralized network digital twin of claim 9, wherein the Request Completion Times (RCT) statistics includes at least one of a mean RCT value, a minimum RCT value, a maximum RCT value, or a median RCT value aggregated for every second.

11. The centralized network digital twin of claim 9, wherein, for a subsequent prediction length, the at least one of the Request Completion Times (RCT) statistics, the Requests Per Second (RPS), or the Number of Pods is replaced with measured values.

12. The centralized network digital twin of claim 9, wherein for a subsequent prediction, the RPS is replaced with a measured RPS value, the number of pods is dropped, and a context window is shifted by one so that new RCT inputs incorporate a last prediction.

13. The centralized network digital twin of claim 8, wherein the output is predicted iteratively to obtain a prediction for a total test duration.

14. The centralized network digital twin of claim 8, wherein the output is predicted in the autoregressive manner using a black box approach using data-driven Machine Learning (ML) modeling based on measurements to learn dependencies between the input and Key Performance Metrics (KPMs).

15. A non-transitory computer-readable media having computer-readable instructions stored thereon, which when executed causes operations to be performed comprising:
receiving, as input, data for lagged contexts of a predetermined context length of a microservices architecture;
based on the received data, predicting output in an autoregressive manner for a selected prediction length using Machine Learning (ML); and
using the output to configure the microservices architecture.

16. The non-transitory computer-readable media of claim 15, wherein the receiving, as the input, the data includes receiving at least one of Request Completion Times (RCT) statistics, Requests Per Second (RPS), or a Number of Pods having a predetermined granularity and wherein the predicting the output includes predicting one or more of Request Completion Times (RCT) statistics, Requests Per Second (RPS), or the Number of Pods corresponding to a next prediction length interval.

17. The non-transitory computer-readable media of claim 16, wherein the receiving the Request Completion Times (RCT) statistics includes receiving at least one of a mean RCT value, a minimum RCT value, a maximum RCT value, or a median RCT value aggregated for every second.

18. The non-transitory computer-readable media of claim 16 further comprising, for a subsequent prediction length, replacing the at least one of the Request Completion Times (RCT) statistics, the Requests Per Second (RPS), or the Number of Pods with measured values.

19. The non-transitory computer-readable media of claim 16 further comprising, for a subsequent prediction, replacing the RPS with a measured RPS value, dropping the number of pods, and shifting a context window by one so that new RCT inputs incorporate a last prediction.

20. The non-transitory computer-readable media of claim 15, wherein the predicting the output in the autoregressive manner includes using a black box approach using data-driven Machine Learning (ML) modeling using measurements to learn dependencies between the input and Key Performance Metrics (KPMs).
